(19) United States
(12) Patent Application Publication
(10) Pub. No.: US 2018/0107032 A1
(43) Pub. Date: Apr. 19, 2018

(54) AUTOMATIC BONDING APPARATUS AND BONDING METHOD

(71) Applicants: BOE TECHNOLOGY GROUP CO., LTD., Beijing (CN); HEFEI BOE OPTOELECTRONICS TECHNOLOGY CO., LTD., Anhui (CN)

(72) Inventors: Zhuang Liu, Beijing (CN); Baogui CAO, Beijing (CN); Hao CHEN, Beijing (CN); Min YOU, Beijing (CN); Guanghua HU, Beijing (CN); Rei REN, Beijing (CN); Yadong LIU, Beijing (CN); Yinchu ZHAO, Beijing (CN)

(73) Assignees: BOE TECHNOLOGY GROUP CO., LTD., Beijing (CN); HEFEI BOE OPTOELECTRONICS TECHNOLOGY CO., LTD., Anhui (CN)

(21) Appl. No.: 15/541,781

(22) PCT Filed: Sep. 27, 2016
(86) PCT No.: PCT/CN2016/100302

§ 371 Date: Jul. 6, 2017

(30) Foreign Application Priority Data
Apr. 15, 2016 (CN) 201610237484.0

(51) Int. Cl. G02F 1/13; G02F 1/1333; B32B 37/12; B65G 49/06; B32B 37/10

(52) U.S. Cl. CPC G02F 1/1303; G02F 1/13338; B32B 2037/1253; B65G 49/068; B32B 37/1018; B32B 37/12

(57) ABSTRACT

A bonding apparatus and a bonding method, the bonding apparatus includes at least one first bonding device, at least two second bonding devices and a transferring device. The first bonding device is configured to visually align and bond an optically clear adhesive and a first component, to form a first bonding component. The transferring device is configured to transfer the first bonding component to the second bonding device. The second bonding device is configured to visually align and bond the first bonding component and a second component, to form a second bonding component.

### CROSS-REFERENCE TO RELATED APPLICATIONS

The present application is based on International Application No. PCT/CN2016/100302, filed on Sep. 27, 2016, which is based upon and claims priority to Chinese Patent Application No. 201610237484.0, filed Apr. 15, 2016, and the entire contents thereof are incorporated herein by reference.

### TECHNICAL FIELD

The present disclosure generally relates to the bonding technology, and more particularly, to an automatic bonding apparatus and bonding method.

### BACKGROUND

An optically clear adhesive (OCA) is an adhesive for gluing transparent optical elements such as lenses. The OCA is colorless and transparent, 90% or above light transmittable, good in gluing strength, can be cured at room temperature or medium temperature, and has small cure shrinkage, and other characteristics. The OCA is one of the important raw materials for producing touch screens. Generally, the OCA is formed by making optical acrylic adhesive as a non-backing series, and then attaching a layer of release film to upper and lower bottom layers of the non-backing series. In short, the OCA is a matrix-free double-sided bonding tape.

Currently, the full-lamination technology is widely used in the manufacture of a display device, to bond a protective glass cover-plate and/or a touch screen with a display screen. The full-lamination technology employing the optically clear adhesive usually includes a soft-to-hard bonding process and a hard-to-hard bonding process. The so-called soft-to-hard bonding process means that the optically clear adhesive is attached to the protective glass cover-plate or the touch screen. The so-called hard-to-hard bonding process is a process in which the protective glass cover-plate or the touch screen attached with the optically clear adhesive is attached to the display screen. In the existing full-lamination technology, the soft-to-hard and hard-to-hard bonding processes are respectively performed in two separate devices. That is to say, the soft-to-hard bonding process is performed in a soft-to-hard bonding device, and the hard-to-hard bonding process is performed in a hard-to-hard bonding device. Therefore, an optical device formed by the soft-to-hard bonding process needs to be transferred to the hard-to-hard bonding device from the soft-to-hard bonding device. However, there are various risks of poor transportation during the transport of the optical device, which decreases the yield of the device subject to the soft-to-hard bonding process.

It should be noted that, information disclosed in the above background portion is provided only for better understanding of the background of the present disclosure, and thus it may contain information that does not form the prior art known by those ordinary skilled in the art.

### SUMMARY

Embodiments of the present disclosure propose a bonding apparatus and a bonding method.

According to an aspect of the present disclosure, there is provided a bonding apparatus, which includes at least one first bonding device, a transferring device and at least two second bonding devices. The first bonding device is configured to visually align and bond an optically clear adhesive and a first component, to form a first bonding component. The transferring device is configured to transfer the first bonding component to the second bonding device. The second bonding device is configured to visually align and bond the first bonding component and a second component, to form a second bonding component. The transferring device is further configured to transfer the second bonding component.

According to another aspect of the present disclosure, there is provided a bonding method performed in the above-described bonding apparatus. In the method, in the first bonding device of the bonding apparatus, the optically clear adhesive and the see-through component are visually aligned and bond to form a first bonding component. Next, the first bonding component is transferred to the second bonding device of the bonding apparatus. In the second bonding device, the first bonding component and the second component are visually aligned and bonded to form a second bonding component.

### BRIEF DESCRIPTION OF THE DRAWINGS

In order to more clearly describe the technical solution of the embodiments of the present disclosure, the drawings of the embodiments will be briefly described below. It will be apparent that the drawings in the following description are merely illustrative of some of the embodiments of the present disclosure and are not intended to limit the present disclosure.

FIG. 1 is a schematic structure diagram illustrating a bonding apparatus 100 according to an embodiment of the present disclosure;

FIG. 2 is a schematic block diagram illustrating a first bonding device of the bonding apparatus 100 shown in FIG. 1;

FIG. 3 is a schematic block diagram illustrating a second bonding device of the bonding apparatus 100 shown in FIG. 1;

FIG. 4 is a schematic diagram illustrating a hardware structure of an example of a bonding apparatus according to an embodiment of the present disclosure;

FIG. 5 is a schematic flow chart showing a bonding method according to an embodiment of the present disclosure; and

FIG. 6 is a schematic flow chart showing an exemplary bonding method performed in the bonding apparatus shown in FIG. 4.

### DETAILED DESCRIPTION

Exemplary embodiments of the present disclosure will now be introduced with reference to the accompanying drawings. However, the present disclosure may be embodied in many different forms and is not limited to the embodiments described herein. Such embodiments are provided to thoroughly and completely disclose the present disclosure, and fully convey the scope of the present disclosure to those skilled in the art. The terms of the exemplary embodiments illustrated in the drawings are not intended to limit the present disclosure. In the drawings, the same units/elements are denoted by the same reference signs.

Unless otherwise stated, the terms (including technical terms) used herein have meaning commonly understood by those skilled in the art. It will be further understood that the terms, defined in the commonly used dictionaries, shall be interpreted as having a meaning consistent with their meaning in the context of the relevant art, and will not be interpreted in an idealized or overly formal sense.

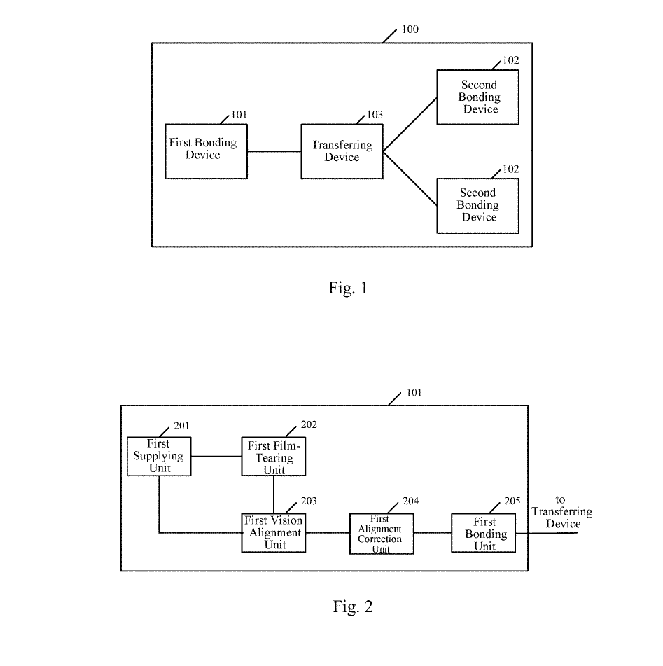

FIG. 1 is a schematic structure diagram illustrating the bonding apparatus 100 according to an embodiment of the present disclosure. As illustrated in FIG. 1, the bonding apparatus 100 may include at least one first bonding device 101 (as an example, only one first bonding device is shown in FIG. 1), at least two second bonding devices 102 (as an example, only two second bonding devices are shown in FIG. 1), and a transferring device 103.

In the bonding apparatus 100, the first bonding device 101 can implement a soft-to-hard process. Specifically, the first bonding device 101 visually aligns an optically clear adhesive with a first component. After the optically clear adhesive is aligned with the first component, the optically clear adhesive and the first component is bonded to form a first bonding component is formed. Therefore, the first bonding component is the first component attached with the optically clear adhesive.

The second bonding device 102 can implement a hard-to-hard bonding process. Specifically, the second bonding device 102 may visually align the first bonding component formed through the first bonding device 101 with a second component. After the first bonding component is aligned with the second component, the first bonding component and the second component is bonded to form a second bonding component. Therefore, the second bonding component is consisted by the first component, the second component, and the optically clear adhesive bonded therebetween.

The transferring device 103 may transfer the first bonding component to the second bonding device 102 from the first bonding device 101 and may further transfer the second bonding component. In the embodiments of the present disclosure, the transferring device 103 may be designed in the form of an assembly line. In this case, the transferring device 103 may include a conveyor belt and at least one gripping unit. The first bonding component and the second bonding component may be transported through the conveyor belt. The gripping unit may grip the first bonding component from the conveyor belt and put it into the second bonding device 102. In the embodiments of the present disclosure, the gripping unit may be a manipulator.

In the embodiments of the present disclosure, each first bonding device 101 may relate to two or more second bonding devices 102, to provide the first bonding component to the related second bonding device 102. In one embodiment, the number of the corresponding second bonding devices 102 may be determined based on a speed at which the first bonding device 101 produces the first bonding component. FIG. 1 illustrates a case where one first bonding device 101 corresponds to two second bonding devices 102.

The bonding apparatus 100 of the present embodiment may be applied to a full-lamination technology used in the manufacture of a display device. In this case, the first component may be a see-through component (e.g., a protective glass cover-plate) or a touch component (e.g., a touch screen), and the second component may be a display module (e.g., a liquid crystal display panel).

Therefore, the bonding apparatus 100 according to the present embodiment can improve the yield and productivity of the bonding components by effectively integrating the soft-to-hard and hard-to-hard bonding processes in the full-lamination technology. In addition, because the bonding apparatus 100 according to the embodiments of the present disclosure is implemented as one apparatus, it is possible to eliminate the risk of poor transportation caused by that the soft-to-hard bonding process and the hard-to-hard bonding process are separately performed in two apparatuses.

FIG. 2 is a schematic block diagram illustrating the first bonding device 101 in the bonding apparatus 100 shown in FIG. 1. As illustrated in FIG. 2, the first bonding device 101 may include a first supplying unit 201, a first film-tearing unit 202, a first vision alignment unit 203, a first alignment correction unit 204, and a first bonding unit 205.

The first supplying unit 201 may store and supply the optically clear adhesive and the first component. In the embodiments of the present disclosure, the first supplying unit 201 may include a plurality of optically clear adhesive cartridges and a first component supplying unit. Each of the plurality of optically clear adhesive cartridges may store the optically clear adhesive and alternately supply the optically clear adhesive. The first component supplying unit may supply the first component.

The first film-tearing unit 202 may peel off a light-release film of the optically clear adhesive. In general, the optically clear adhesive has a protective film (i.e., the light-release film and a heavy-release film) to prevent the failure of the adhesive material. Furthermore, a film-tearing label (also referred to as a tear tape) may be provided on the protective film to facilitate the peeling-off of the protective film. In the embodiments of the present disclosure, the first film-tearing unit 202 may utilize the film-tearing label to peel off the light-release film. The first film-tearing unit 202 may automatically get the film-tearing label of the light-release film.

The first vision alignment unit 203 may visually align the optically clear adhesive with the first component to ensure the bonding effect. In the embodiments of the present disclosure, the first vision alignment unit 203 may be, for example, an imaging apparatus of a camera.

In addition, in the embodiments of the present disclosure, the first bonding device 101 may further include the first alignment correction unit 204. The first alignment correction unit 204 may correct the vision alignment of the optically clear adhesive with the first component to improve the accuracy of the vision alignment. In the embodiments of the present disclosure, the first alignment correction unit 204 may perform alignment correction by using a vision alignment correction technology based on a charge coupled element (CCD). The first alignment correction unit 204 may use a high-end visual device.

In the embodiments of the present disclosure, the yield of the first bonding component can be improved by the vision alignment technology and the vision alignment correction technology so that a subsequent operation can be directly performed on the first bonding component.

The first bonding unit 205 may bond one surface of the optically clear adhesive from which the light-release film has been peeled off and the first component, to form the first bonding component. In the embodiments of the present disclosure, the first bonding unit 205 may utilize roller bonding, such as a platform roller or a mesh cage roller. In addition, while bonding the optically clear adhesive and the first component, the first bonding unit 205 may also be configured to, when the optically clear adhesive and the first component are bonded, adjust a pressure applied on the optically clear adhesive and the first component and a bonding speed by stages.

In addition, the first bonding device 101 may further include a first detection unit and a first output unit. The first detection unit may detect whether there is a space on the conveyor belt of the transferring device 103. The first output unit outputs the first bonding component to the conveyor belt when the first detection unit detects that there is a space on the conveyor belt. In this way, the first bonding component may be put at the space on the conveyor belt to avoid the stacking of the plurality of first bonding components on the conveyor belt.

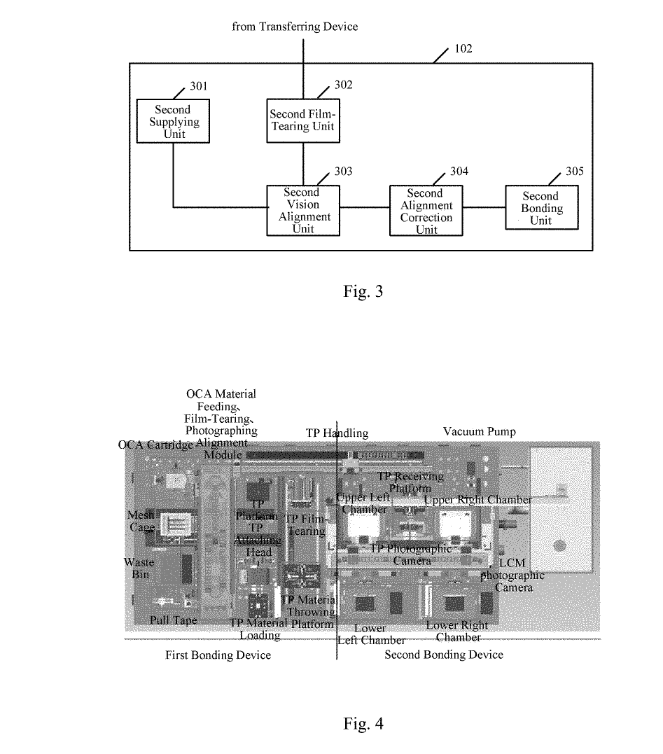

FIG. 3 is a schematic block diagram illustrating the second bonding device 102 in the bonding apparatus 100 shown in FIG. 1. As illustrated in FIG. 3, the second bonding device 102 may include a second supplying unit 301, a second film-tearing unit 302, a second vision alignment unit 303, a second alignment correction unit 304, and a second bonding unit 305.

The second supplying unit 301 may store and supply the second component.

The second film-tearing unit 302 may peel off the heavy-release film from the optically clear adhesive of the first bonding component transferred through the transferring device 103. In the embodiments of the present disclosure, a roll-type peeling-off tape may be used to continuously peel off the heavy-release film. An adhesive surface of the optically clear adhesive, from which the heavy-release film is peeled off, may be bonded to the second component.

The second vision alignment unit 303 may visually align the first bonding component and the second component to ensure the bonding effect. In the embodiments of the present disclosure, the second vision alignment unit 303 may include an imaging apparatus such as a camera, a video camera.

After the first bonding component is visually aligned with the second component, the second alignment correction unit 304 may correct the vision alignment of the first bonding component with the second component so as to improve the accuracy of the vision alignment. In the embodiments of the present disclosure, the second alignment correction unit 304 may perform alignment correction by adopting a vision alignment correction technology based on a charge coupled element (CCD). The second alignment correction unit 304 may use a high-end visual device.

The second bonding unit 305 may bond one surface of the optically clear adhesive of the first bonding component to the second component to form the second bonding component, and the heavy-release film has been peeled off from the one surface of the optically clear adhesive. In the embodiments of the present disclosure, the second bonding unit 305 may bond the first bonding component and the second component through vacuum bonding. That is, the second bonding unit 305 may laminate the first bonding component and the second component by the optically clear adhesive in a vacuum chamber.

In addition, the second bonding device 102 may further include a second detection unit and a second output unit. The second detection unit may detect whether there is a space on the conveyor belt of the transferring device 103. When the second detection unit detects that there is a space on the conveyor belt, the second output unit outputs the second bonding component to the vacant position on the conveyor belt. In this way, the second bonding component may be placed at the space on the conveyor belt to avoid the stacking of the plurality of second bonding components on the conveyor belt.

In addition, in the embodiments of the present disclosure, the bonding apparatus 100 may further include a sampling inspection device. The sampling inspection device may acquire and output the first bonding component regularly in order to detect the quality of the first bonding component.

In the above-described embodiments, the first bonding device 101 and the second bonding device 102 individually includes a supplying unit, a film-tearing unit, a vision alignment unit, a alignment correction unit, a detection unit, and an output unit. Alternatively, the first bonding device 101 and the second bonding device 102 may share a supplying unit, a film-tearing unit, a vision alignment unit, a alignment correction unit, a detection unit, and an output unit.

FIG. 4 is a schematic diagram illustrating a hardware structure of an example of a bonding apparatus according to an embodiment of the present disclosure. The bonding apparatus 400 in this example may be applied to the full-lamination of a liquid crystal display device. As illustrated in FIG. 4, the bonding apparatus 400 in the example includes a first bonding device 401, a transferring device, and a second bonding device 402. In this example, the first component is a touch panel, and the second component is a liquid crystal display module.

In the first bonding device, an OCA cartridge 411 stores and supplies the optically clear adhesive. A touch panel (TP) material loading unit 430 supplies the touch panel. A TP platform 425 may hold one or more touch panels.

In the first bonding device, a camera may visually align the optically clear adhesive with the touch panel. Further, after the optically clear adhesive and the touch panel are visually aligned, the alignment correction unit corrects the vision alignment of the optically clear adhesive and the touch panel.

In the first bonding device, a pull tape 413 corresponds to the first film-tearing unit and is used as to peel off the light-release film of the optically clear adhesive by using the film-tearing label. In addition, a TP film-tearing unit 426 may peel off a protective film from the touch panel.

In the first bonding device, the optically clear adhesive and the touch panel may be bond in a mesh cage 424 by using a cage mesh roller to form the first bonding component (in this example, it is the touch panel attached with the optically clear adhesive). In addition, it is possible to adjust a pressure applied on the optically clear adhesive and the touch panel and a bonding speed by stages when the optically clear adhesive and the touch panel are bonded.

In the first bonding device, a TP material throwing platform 414 may be used for sampling inspection and material throwing of the first bonding component.

In the first bonding device, a waste bin 423 is a device configured to recover the first bonding component whose sampling inspection result is unqualified.

The transferring device may include a working table and a TP handling manipulator 415, to transfer the first bonding component to the second bonding device from the first bonding device. The first bonding component may be placed at the space of the working table to avoid the stacking it on the other first bonding components.

In the second bonding device, a liquid crystal display module material loading unit may supply the liquid crystal display module. The supplied liquid crystal display module is placed in a lower left chamber 416 and a lower right chamber 417. A TP receiving platform 424 may get the transferred first bonding component from the TP transportation manipulator and move the first bonding component to an upper left chamber 418 and an upper right chamber 419.

In the second bonding device, a TP photographic camera 420 performs vision alignment on the first bonding component and the liquid crystal display module. Further, after the first bonding component is visually aligned with the liquid crystal display module, a liquid crystal display module (LCM) photographic camera 421 corrects the vision alignment.

In the second bonding device, the heavy-release film of the optically clear adhesive of the first bonding component may be continuously peeled off by using the roll-type peeling-off tape.

In the second bonding device, the first bonding component and the liquid crystal display module are bonded through vacuumizing by a vacuum pump 422 to form the second bonding component (in this example, it is a touch display device formed by bonding the touch panel and the liquid crystal display module by using the optically clear adhesive).

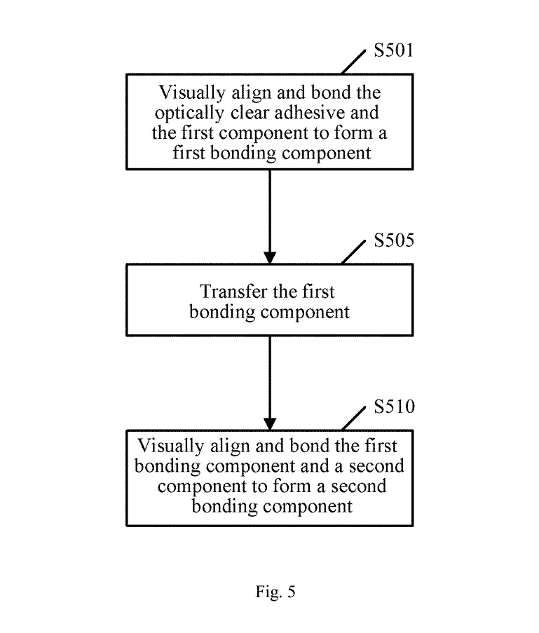

FIG. 5 is a schematic flow chart showing a bonding method according to an embodiment of the present disclosure. The method may be performed in the bonding apparatus shown in FIGS. 1 to 4. In the following description, the description of the same portions as those of the foregoing embodiments will be omitted.

As illustrated in FIG. 5, in step S501, in the first bonding device of the bonding apparatus, an optically clear adhesive and a first component are visually aligned and bonded to form a first bonding component.

In the step S501, firstly, the optically clear adhesive and the first component are obtained. Next, a light-release film of the optically clear adhesive is peeled off. The light-release film may be peeled off by a film-tearing label provided on the light-release film. The film-tearing label may be automatically obtained. The optically clear adhesive is then visually aligned with the first component. And then, one surface of the optically clear adhesive from which the light-release film has been peeled off and the first component are bond to form the first bonding component.

In the step S501, after the optically clear adhesive and the first component are visually aligned, the vision alignment of the optically clear adhesive and the first component may further be corrected.

Furthermore, in the step S501, in the bonding of the optically clear adhesive and the first component, a pressure applied on the optically clear adhesive and the first component and a bonding speed can be adjusted by stages.

Returning to FIG. 5, in step S505, the formed first bonding component is transferred to the second bonding device. In this step, the transferring may be implemented by utilizing an assembly line. Then, in step S510, in the second bonding device, the first bonding component and the second component are visually aligned with each other and bonded to form the second bonding component.

In the step S510, firstly, the second component is obtained. Next, a heavy-release film of the optically clear adhesive of the first bonding component is peeled off. In the embodiments of the present disclosure, the heavy-release film of the optically clear adhesive may be continuously peeled off by using a roll-type peeling-off tape. Then, the first bonding component is visually aligned with the second component, and one surface of the optically clear adhesive of the first bonding component, from which the heavy-release film is peeled off, is bonded to the second component.

In the step S510, after the first bonding component and the second component are visually aligned, correction may be further performed on the vision alignment.

In addition, in the step S510, in the bonding of the first bonding component and the second component, the first bonding component and the second component are bonded through vacuum bonding.

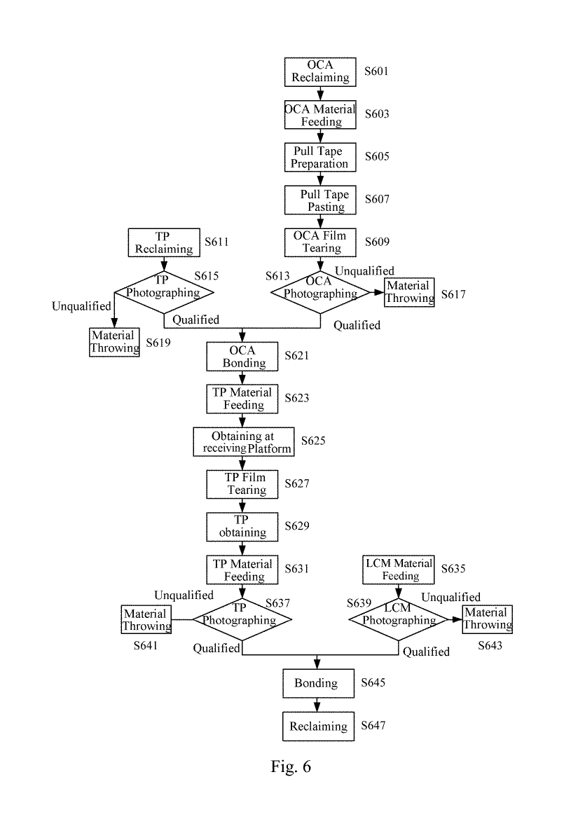

FIG. 6 is a schematic flow chart showing an exemplary bonding method performed in the bonding apparatus shown in FIG. 4. In the exemplary method, a touch panel (TP) serves as the first component, and the liquid crystal display module servers as the second component.

Firstly, in step S601, an optically clear adhesive is alternately obtained from two OCA cartridges; and in step S603, the optically clear adhesive is put on a working table.

Next, in step S605, a pull tape is provided to serve as the film-tearing label; and in step S607, the pull tape is pasted. In step S609, the pull tape is used to peel off a light-release film of the optically clear adhesive, and a next pull tape is automatically obtained.

On the other hand, in step S611, a TP material loading unit is used to supply the touch panel (TP). Next, in steps S613 and S615, the optically clear adhesive and the touch panel are photographed for performing the vision alignment. If the vision alignment between the optically clear adhesive and the touch panel is not up to standard, the corresponding optically clear adhesive and touch panel are discarded in steps S617 and S619.

Then, in step S621, the visually-aligned optically clear adhesive and touch panel are bond to form the touch panel attached with the optically clear adhesive, which is the first bonding component. In the bonding of the optically clear adhesive and the touch panel, a pressure applied on the the optically clear adhesive and the touch panel and a bonding speed by stages may be adjusted by stages.

Next, in step S623, the touch panel attached with the optically clear adhesive is put into the second bonding device; and in step S625, the touch panel attached with the optically clear adhesive is obtained at the TP receiving platform.

Next, in step S627, a heavy-release film of the optically clear adhesive is peeled off by using a roll-type peeling-off tape.

Next, in step S629, the touch panel attached with the optically clear adhesive, from which the heavy-release film is peeled off, is obtained; and in step S631, the touch panel is put into the upper left chamber and the upper right chamber.

On the other hand, in step S635, the liquid crystal display module (LCM) is obtained by the liquid crystal display module material feeding unit. Next, in steps S637 and S639, the touch panel attached with the optically clear adhesive and the liquid crystal display module are photographed for performing the vision alignment. If the vision alignment of the touch panel attached with the optically clear adhesive and the liquid crystal display module is not up to standard, the corresponding touch panel attached with the optically clear adhesive and the liquid crystal display module are discarded in steps S641 and S643.

Then, in step S645, the touch panel attached with the optically clear adhesive and the liquid crystal display module are bond through vacuum bonding to form a touch display device. Finally, in step S647, the formed touch display device may be taken out.

The foregoing contents are merely examples of specific embodiments of the present disclosure, but the scope of protection of the present disclosure is not limited thereto. It will be apparent to those skilled in the art that modifications, variations or substitutions may be made within the technical scope disclosed by the present disclosure and that such transformations are intended to be within the protection scope of the present disclosure. The scope of protection of the present disclosure is subject to the scope of the appended claims.

1. A bonding apparatus, comprising:
at least one first bonding device configured to visually align and bond an optically clear adhesive and a first component, to form a first bonding component;
at least two second bonding devices configured to visually align the first bonding component and a second component and bond the first bonding component and the second component by the optically clear adhesive, to form a second bonding component; and
a transferring device configured to transfer the first bonding component to the second bonding device, and transfer the second bonding component.

2. The bonding apparatus according to claim 1, wherein the first bonding device comprises:
a first supplying unit configured to supply the optically clear adhesive and the first component;
a first film-tearing unit configured to peel off a light-release film of the optically clear adhesive;
a first vision alignment unit configured to visually align the optically clear adhesive and the first component; and
a first bonding unit configured to bond one surface of the optically clear adhesive to the first component, the light-release film having been peeled off from the one surface of the optically clear adhesive.

3. The bonding apparatus according to claim 2, wherein the first bonding device further comprises: a first alignment correction unit configured to correct the vision alignment of the optically clear adhesive and the first component.

4. The bonding apparatus according to claim 2, wherein the first bonding unit is further configured to, when the optically clear adhesive and the first component are bonded, adjust a pressure applied on the optically clear adhesive and the first component and a bonding speed by stages.

5. The bonding apparatus according to claim 1, wherein the second bonding device comprises:
a second supplying unit configured to supply the second component;
a second film-tearing unit configured to peel off a heavy-release film of optically clear adhesive of the first bonding component;
a second vision alignment unit configured to visually align the first bonding component and the second component; and
a second bonding unit configured to bond one surface of the optically clear adhesive of the first bonding component to the second component, the heavy-release film having been peeled off from the one surface of the optically clear adhesive of the first bonding component.

6. The bonding apparatus according to claim 5, wherein the second bonding device further comprises: a second alignment correction unit configured to correct the vision alignment of the first bonding component and the second component.

7. The bonding apparatus according to claim 5, wherein the second bonding unit is configured to bond the first bonding component and the second component through vacuum bonding.

8. The bonding apparatus according to claim 1, wherein the transferring device comprises:
a conveyor belt, wherein the first and second bonding components are transported on the conveyor belt; and
at least one gripping unit configured to grip the first bonding component from the conveyor belt and put the first bonding component into the second bonding device.

9. The bonding apparatus according to claim 8, wherein the first bonding device further comprises:
a first detection unit configured to detect whether there is a space on the conveyor belt; and
a first output unit configured to output, upon detection of the space, the first bonding component to the conveyor belt.

10. The bonding apparatus according to claim 8, wherein the second bonding device further comprises:
a second detection unit configured to detect whether there is a space on the conveyor belt; and
a second output unit configured to output, upon detection of the space, the second bonding component to the conveyor belt.

11. The bonding apparatus according to claim 1, wherein each first bonding device corresponds to two second bonding devices.

12. The bonding apparatus according to claim 1, wherein the first component is a see-through component or a touch component, and the second component is a display module.

13. A bonding method performed in the bonding apparatus according to claim 1, comprising:
in the first bonding device of the bonding apparatus, visually aligning and bonding the optically clear adhesive and the first component to form a first bonding component;
transferring the first bonding component to the second bonding device of the bonding apparatus; and
in the second bonding device, visually aligning the first bonding component and a second component and bonding the first bonding component and the second component by the optically clear adhesive, to form a second bonding component.

14. The bonding method according to claim 13, wherein the step of forming of the first bonding component comprises:
obtaining the optically clear adhesive and the first component;
peeling off a light-release film of the optically clear adhesive;
visually aligning the optically clear adhesive and the first component; and
bonding one surface of the optically clear adhesive to the first component, the light-release film having been peeled off from the one surface of the optically clear adhesive.

15. The bonding method according to claim 14, wherein the step of forming of the first bonding component further comprises correcting the vision alignment of the optically clear adhesive and the first component.

16. The bonding method according to claim 14, wherein the step of bonding of the optically clear adhesive and the first component comprises adjusting a pressure applied on the optically clear adhesive and the first component and a bonding speed by stages.

17. The bonding method according to claim 13, wherein the step of forming of the second bonding component comprises:
obtaining the second component;
peeling off a heavy-release film of the optically clear adhesive of the first bonding component;
visually aligning the first bonding component and the second component; and
bonding one surface of the optically clear adhesive of the first bonding component to the second component, the heavy-release film having been peeled off from the one surface of the optically clear adhesive of the first bonding component.

18. The bonding method according to claim 17, wherein the step of forming of the second bonding component further comprises correcting the vision alignment of the first bonding component and the second component.

19. The bonding method according to claim 17, wherein in the bonding of the first bonding component and the second component, the first bonding component and the second component are bonded through vacuum bonding.

20. The bonding method according to claim 13, wherein the first component is a see-through component or a touch component, and the second component is a display module.
